(19) United States
(12) Patent Application Publication
(10) Pub. No.: US 2022/0242785 A1
(43) Pub. Date: Aug. 4, 2022

(54) COMPOSITIONS CONTAINING CONCRETE AND SOLID WASTE COMPOSITIONS

(71) Applicant: Ecogensus LLC, Hartford, CT (US)

(72) Inventor: Bjornulf Ostvik, Hartford, CT (US)

(21) Appl. No.: 17/591,266

(22) Filed: Feb. 2, 2022

Related U.S. Application Data
(60) Provisional application No. 63/144,803, filed on Feb. 2, 2021.

(51) Int. Cl. C04B 18/20; C04B 28/02; C04B 18/30; C04B 18/24; C04B 40/00; C04B 16/04

(52) U.S. Cl. CPC C04B 18/20; C04B 28/02; C04B 18/305; C04B 2111/00767; C04B 40/0028; C04B 16/04; C04B 18/24

(57) ABSTRACT

Compositions containing cement or concrete and processed solid waste are provided herein, as are products made from the compositions, and systems and methods for making the compositions and products.

### CROSS-REFERENCE TO RELATED APPLICATIONS

This application claims benefit of priority from U.S. Provisional Application Ser. No. 63/144,803, filed on Feb. 2, 2021. The disclosure of the prior application is considered part of (and is incorporated by reference in) the disclosure of this application.

### TECHNICAL FIELD

This document relates to compositions containing cement or concrete and processed solid waste, products made from the compositions, and systems and methods for making the compositions and products.

### BACKGROUND

Incineration ash is used in masonry products or for roadway construction in many parts of the world. When waste (including solid waste, such as municipal solid waste) is combusted in incineration facilities, a significant portion—often as much as a third of the input weight—is left as ash that may be used in masonry products. Where incineration already exists, it is generally preferable to use the resulting ash instead of merely disposing of the waste. Indeed, almost all incineration ash in many countries, including the United States, is landfilled. However, the use of incineration as a means to obtain ash is associated with many drawbacks, including the requirement for an incineration facility that may be expensive to run and must comply with various regulations (e.g., for mitigating emissions). In addition, bottom ash usually must be separated from the fly ash, since only the bottom ash is typically used as a concrete additive. The ash also typically contains uncombusted materials (e.g., metals and glass), as well as unfavorable combustion byproducts (e.g., particulates), thus causing the ash byproducts of incineration to be unsuitable for many reuse applications. Alternative methods for reusing solid waste as a resource, with greater overall economic and energy efficiency as well as congruency with environmentally sound practices, is sought worldwide as solid waste generation continues to increase.

### SUMMARY

This document is based, at least in part, on the development of methods, materials, and systems for generating composites (e.g., structural and non-structural composites) from processed mixed waste and cement. The composites can be used in the production of, for example, construction materials and other products. For example, this document provides methods, materials, and systems for processing the components of sorted solid waste (e.g., solid waste from which glass and metals have been removed) by heating the remaining components and mixing them with cement to generate sustainable, strong construction materials.

The compositions and methods provided herein advantageously are ecologically-friendly, using relatively low temperature heat, negative pressure, and mechanical blending to process waste without combustion or incineration. The systems for processing solid waste streams can, in some cases, be installed into existing waste management facilities or used in any other appropriate setting, and represent a community-friendly and synergistic approach to processing and repurposing waste. In some cases, the methods can include pre-sorting to yield a solid waste composition that is substantially free of components such as glass, metals, and/or rock. In some cases, subsequent pre-processing can remove nearly all moisture; such pre-processing can be conducted at temperatures sufficient to achieve thermolytic reactions for the hemicellulose and cellulose components of the biomass materials, leaving intact the lignin that can contribute to material strength. As described herein, the resulting material can be used as an component or even a core material for sustainable, alternative masonry products.

The methods described herein are cost- and energy-efficient, and provide the ability to efficiently process the inherently heterogeneous contents of solid waste compositions into a raw material suitable for producing sustainable, concrete-containing construction products.

In a first aspect, this document features a composite that contains (a) cement and (b) a solid waste composition containing organic material and about 2 wt. % to about 65 wt. % mixed plastics, where the solid waste composition contains from about 40 wt. %. to about 86 wt. % carbon, from about 3 wt. % to about 20 wt. % hydrogen, oxygen, and from about 0.1 wt. % to about 15 wt. % water. The solid waste composition can have been heated to a temperature of 38° C. to 210° C. prior to being combined with the cement. The composite can have a compressive strength of at least 2500 psi, at least 4000 psi, or at least 5000 psi. The composite can have a compressive strength that is at least 50% greater than the compressive strength of the solid waste composition. The composite can contain about 5 wt. % to about 30 wt. % of the cement, about 10 wt. % to about 20 wt. % of the cement, about 20 wt. % to about 25 wt. % of the cement, or about 25 wt. % to about 30 wt. % of the cement. The composite can contain about 0.1 wt. % to about 5 wt. % water, or about 0.5 wt. % to about 10 wt. % water. The mixed plastics can include two or more plastics selected from the group consisting of polyester, polyethylene terephthalate, polyethylene, polyvinyl chloride, polyvinylidene chloride, polypropylene, polystyrene, polyamides, acrylonitrile-butadiene-styrene, polyethylene/acrylonitrile-butadiene-styrene, polycarbonate, polycarbonate/acrylonitrile butadiene styrene, polyurethanes, maleimide/bismaleimide, melamine formaldehyde, phenol formaldehydes, polyepoxide, polyetheretherketone, polyetherimide, polyimide, polylactic acid, polymethylmethacrylate, polytetrafluoroethylene, and urea-formaldehyde. The solid waste composition can be derived from municipal solid waste, agricultural waste, or both. The composite can further include an aggregate material (e.g., sand, gravel, crushed rock, air cooled blast furnace slag, or fill). The composite can further include an added polymer. The composite can contain about 2 wt. % to about 70 wt. % of the added polymer. The added polymer can include a thermoset polymer. The polymer can include an epoxy resin, a fiberglass-reinforced plastic, a phenolic resin, a polyester resin, polyurethane, a polyurea/polyurethane hybrids, a furan resin, a silicone resin, a vinyl ester, a cyanate ester, a melamine resin, a polydicyclopentadiene, benzoxazine, a polyimide, a bismaleimide, an electrical insulating thermoset phenolic laminate material, a nylon, polystyrene, polypropylene, a fluoropolymer, or any combination thereof. The composite can further contain a flame retardant (e.g., a flame retardant selected from the group consisting of phosphate flame retardants, silicon-based flame retardants, metal hydroxide flame retardants, melamine flame retardants, phosphorus-based flame retardants, halogenated flame retardants, brominated flame retardants, and flame retardants made from bio-based chitosan, phytic acid, and divalent metal ions). The composite can further include a biocide (e.g., a biocide selected from the group consisting of copper azole (CuAz), ammoniacal copper quaternary (ACQ), 4,5-dichloro-2-octyl-isothiazolone, zinc pyrithione, and carbendazim. The composite can further include an additive (e.g., recycled plastic or polylactic acid). The composite can further have a coating that forms an exterior surface of the structural composite. The composite can be a molded composite. The composite can be formed as a construction material (e.g., a board, a plank, a stud, a block, an interlocking block, a brick, a strut, a beam, an H-block, a flue, a concrete masonry unit, a paver, a float, an edging brick, a panel, or a stone-shape). The composite can further include a polymer or polymer-based coating on one or more surfaces. The composite can contain about 10 wt. % to about 75 wt. % of the solid waste composition and about 10 wt. % to about 30 wt. % of cement.

In another aspect, this document features a composite containing (a) cement, (b) a solid waste composition that includes mixed plastics and organic material, and (c) water in an amount of about 0.1 wt. % to about 2 wt. %.

In another aspect, this document features a method of making a composite. The method can include (a) heating, in a process vessel, a solid waste composition that contains (i) mixed plastics in an amount of about 2 wt. % to about 70 wt. % of the solid waste composition, and (ii) organic materials, such that at least a portion of the mixed plastics in the solid waste composition become melted; and (b) during or after the heating, combining cement with the solid waste composition. The heating can include heating the solid waste composition to a temperature of about 60° C. to about 200° C. for about 20 minutes to about 4 hours. The composite can contain about 10 wt. % to about 30 wt. % of the cement. The method can further include combining an aggregate material with the solid waste composition and the cement. The method can further include adding a polymer, a filler, a flame retardant, a biocide, or any combination thereof. The method can further include combining a polymer (e.g., a thermoset polymer) with the solid waste composition and the cement. The thermoset polymer can include an epoxy resin, a fiberglass-reinforced plastic, a phenolic resin, a polyester resin, polyurethane, a polyurea/polyurethane hybrids, a furan resin, a silicone resin, a vinyl ester, a cyanate ester, a melamine resin, a polydicyclopentadiene, benzoxazine, a polyimide, a bismaleimide, an electrical insulating thermoset phenolic laminate material, a nylon, polystyrene, polypropylene, a fluoropolymer, or any combination thereof. The method can further include combining a filler (e.g., recycled plastic, PLA, or a resin) with the solid waste composition and the cement. The method can further include combining a biocide (e.g., CuAz, ACQ, 4,5-dichloro-2-octyl-isothiazolone, zinc pyrithione, and carbendazim) with the solid waste composition and the cement. The biocide can be added at a temperature less than 50° C. The method can further include combining a flame retardant (e.g., a flame retardant selected from the group consisting of phosphate flame retardants, silicon-based flame retardants, metal hydroxide flame retardants, melamine flame retardants, phosphorus-based flame retardants, halogenated flame retardants, brominated flame retardants, and flame retardants made from bio-based chitosan, phytic acid, and divalent metal ions) with the solid waste composition and the cement. The method can further include forming the composite into a selected shape, where the forming includes molding the structural composite, and cooling the formed structural composite. The forming can include forming the structural composite into blocks configured to interlock. The composite can contain about 0.1 wt. % to about 15 wt. % water, or about 3 wt. % to about 5 wt. % water. The method can further include applying a polymer or polymer-based coating to one or more surfaces of the composite. The applying can include spraying, dipping, pouring, or powder coating.

In still another aspect, this document features a method of making a composite, where the method includes heating, in a process vessel, a solid waste composition containing mixed plastics and organic materials, and adding cement to the heated solid waste composition.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an illustration of an embodiment of a mold and reinforcing elements that can be used in methods of producing composites.

FIG. 2 is a top view of another embodiment of a reinforcing element that can be included in a composite.

Like reference symbols in the various drawings indicate like elements.

### DETAILED DESCRIPTION

This document provides methods and materials for using typically incinerated or landfilled waste as a raw material for compositions that may be used, for example, in sustainable construction materials. In particular, this document provides methods, materials, and systems for using mixed solid waste in combination with cement, concrete, a cement component, or a cement-like material to generate composites (e.g., structural and non-structural composites), and products containing the composites. In some cases, a mixed solid waste can be pre-treated by partial sorting, heating, mixing, or any combination thereof, to yield a solid waste composition (also referred to herein as a “pre-processed mixed solid waste” or a “thermomechanically processed mixed solid waste”). The solid waste composition can be combined with cement, concrete, a cement component, or a cement-like material to generate a composite provided herein.

In general, the components of a composite produced by the methods provided herein include a combination of a solid waste composition and concrete, cement, or a cement component or cement-like material. In some cases, a composite containing a solid waste composition and concrete or cement also can include an added polymer (e.g., a binding polymer), filler, biocide, flame retardant, or any combination thereof. For example, a composite can include a solid waste composition, concrete, and an added polymer (e.g., a polymer).

“Waste” generally refers to carbon-containing combustible material that has been discarded after its primary use, including solid waste. Generally, the waste may be wet and heterogeneous, containing a portion of non-combustible waste. “Solid waste” refers to any garbage, refuse, sewage sludge from a wastewater treatment plant, water supply treatment plant, or air pollution control facility and other discarded material, including solid, liquid, semi-solid, or contained gaseous material resulting from industrial, commercial (e.g. paper mill/pulp waste), mining, or agricultural operations, or from community activities.

A variety of sources of solid waste can be used to produce the composites provided herein. For example, a solid waste mixture can be derived from non-hazardous waste sources including, but not limited to, municipal waste, agricultural waste, sewage sludge, household waste, discarded secondary materials, and industrial solid waste. “Municipal waste” or MSW may refer to any household waste or commercial solid waste or industrial solid waste. Non-limiting examples of wastes that may be included in the solid waste mixture include biodegradable waste such as food and kitchen waste, green wastes such as lawn or hedge trimmings, paper, mixed plastics, solid food waste, solid agricultural waste, sewage sludge, and automotive shredder residue.

“Household waste” or “residential waste” refers to any solid waste (including garbage, trash, and sanitary waste in septic tanks) derived from households (including single and multiple residences, hotels and motels, bunkhouses, ranger stations, crew quarters, campgrounds, picnic grounds, and day-use recreation areas).

“Commercial solid waste” refers to all types of solid waste generated by stores, offices, restaurants, warehouses, and other nonmanufacturing activities, excluding residential and industrial wastes.

“Industrial solid waste” refers to non-hazardous solid waste generated by manufacture or industrial processes. Examples of industrial solid waste include, without limitation, waste resulting from manufacturing processes such as electric power generation, production of fertilizer and agricultural chemicals, production of food and related products, production of leather and leather products, production of organic chemicals, plastic and resin manufacturing, production of pulp and paper, production of rubber and miscellaneous plastic products, textile manufacturing, production of transportation equipment, and water treatment. The term “industrial solid waste” does not include mining waste or oil and gas waste.

In some cases, a solid waste mixture can contain discarded non-hazardous secondary material, in which case composites produced from those solid waste mixtures may be legally categorized as “non-waste.” “Secondary material” refers to any material that is not the primary product of a manufacturing or commercial process, and can include post-consumer material, off-specification commercial chemical products or manufacturing chemical intermediates, post-industrial material, and scrap. Examples of non-hazardous secondary materials include scrap tires that are not discarded and are managed by an established tire collection program, including tires removed from vehicles and off-specification tires, resinated wood, coal refuse that has been recovered from legacy piles and processed in the same manner as currently-generated coal refuse, and dewatered pulp and paper sludges that are not discarded and are generated and burned on-site by pulp and paper mills that burn a significant portion of such materials where such dewatered residuals are managed in a manner that preserves the meaningful heating value of the materials.

“Resinated wood” refers to wood products that contain binders and/or adhesives and are produced by primary and secondary wood products manufacturing. Resinated wood includes residues from the manufacture and use of resinated wood, including materials such as board trim, sander dust, panel trim, and off-specification resinated wood products that do not meet a manufacturing quality or standard.

“Mixed plastics” refer to any combination of synthetic or semi-synthetic organics that are malleable and can be molded into solid objects of diverse shapes, and typically are found in municipal solid waste. Examples of plastics that may be found in a solid waste composition include, without limitation, polyester (PES), polyethylene terephthalate (PET), polyethylene (PE), high-density polyethylene (HDPE), polyvinyl chloride (PVC), polyvinylidene chloride (PVDC, SARAN™), low-density polyethylene (LDPE), polypropylene (PP), polystyrene (PS), polyamides (PA) (nylons), acrylonitrile butadiene styrene (ABS), polyethylene/acrylonitrile butadiene styrene (PE/ABS), polycarbonate (PC), polycarbonate/acrylonitrile butadiene styrene (PC/ABS), polyurethanes (PU), maleimide/bismaleimide, melamine formaldehyde (MF), phenol formaldehydes (PF), polyepoxide (epoxy), polyetheretherketone (PEEK), polyetherimide (PEI, Ultem™), polyimide, polylactic acid (PLA), polymethyl methacrylate (PMMA, acrylic), polytetrafluoroethylene (PTFE), urea-formaldehyde (UF), and any combination thereof.

In some cases, a solid waste mixture can be analyzed to detect different types of contents. Based on the analysis, a municipal solid waste stream can be lightly sorted to remove waste materials such as, for example, glass, metals (e.g., scrap metal, metal chunks, ferrous metals such as iron, steel, and other iron-containing alloys, and non-ferrous metals that do not contain an appreciable amount of iron), and/or concrete, resulting in a sorted solid waste. It is to be noted, however, that in some cases, a solid waste composition can include unsorted waste (e.g., unsorted municipal solid waste, unsorted agricultural waste, or both). In some cases, a mixed solid waste can be analyzed to determine the amount of mixed plastics present therein. To form a composite provided herein, the mixed solid waste can be combined with one or more added polymers in a ratio that is based on the analysis.

It is to be noted that different solid waste mixtures can have a highly variable composition due to the variable nature of municipal solid waste streams. A municipal solid waste stream may vary in composition due to a variety of factors including, without limitation, different seasons, different locations within a country (e.g., urban versus rural), and/or different countries (e.g., industrial versus emerging). The amount of water contained within a solid waste mixture also can vary, and can influence the time and/or maximum temperature needed to remove the water from the solid waste mixture during the methods described herein. For example, a mixed solid waste used as a feedstock for making a composite provided herein can contain an amount of water ranging from about 10 wt. % to about 85 wt. % (e.g., about 10 wt. % to about 20 wt. %, about 20 wt. % to about 30 wt. %, about 30 wt. % to about 40 wt. %, about 40 wt. % to about 50 wt. %, about 5 50 wt. % to about 60 wt. %, about 60 wt. % to about 70 wt. %, about 70 wt. % to about 80 wt. %, or about 80 wt. % to about 85 wt. %). In some cases, a mixed solid waste can contain at least about 10 wt. % water (e.g., at least about 20 wt. % water, at least about 30 wt. % water, at least about 40 wt. % water, or at least about 50 wt. % water).

In general, the solid waste compositions used in the composites provided herein can include a combination of mixed plastics and organic material (e.g., organic material from waste products such as municipal waste, agricultural waste, or any other appropriate type of waste), and water. The solid waste composition can include, for example, components of MSW and/or agricultural waste, as well as any other appropriate waste. The typical contents of MSW, per the United States Environmental Protection Agency, can be as follows:

| | |
|---|---|
| paper/paperboard | 23.1% |
| food | 21.6% |
| plastics | 12.2% |
| wood | 6.2% |
| yard trimmings | 12.1% |
| rubber and leather | 3.1% |
| textiles | 5.8% |
| glass | 4.2% |
| metals | 8.8% |
| misc. inorganic waste | 1.4% |
| other | 1.5% |

See, epa.gov/facts-and-figures-about-materials-waste-and-recycling/guide-facts-and-figures-report-about-materials.

In some cases, mixed plastics may not be present in a solid waste composition, or may be present in small amounts (e.g., less than 5 wt. %, less than 4 wt. %, less than 3 wt. %, less than 2 wt. %, or less than 1 wt. %). In some cases, mixed plastics can be present in the solid waste composition in an amount from about 2 wt. % to about 65 wt. % (e.g., about 2 wt. % to about 5 wt. %, about 5 wt. % to about 20 wt. %, about 10 wt. % to about 30 wt. %, about 20 wt. % to about 40 wt. %, about 30 wt. % to about 50 wt. %, about 40 wt. % to about 50 wt. %, about 50 wt. % to about 60 wt. %, or about 60 wt. % to about 65 wt. %).

A solid waste composition used in a composite provided herein can include any appropriate amount of carbon and hydrogen. For example, a solid waste composition can contain from about 40 wt. %. to about 86 wt. % carbon (e.g., about 40 wt. % to about 50 wt. %, about 50 wt. % to about 60 wt. % about 60 wt. % to about 70 wt. %, about 70 wt. % to about 80 wt. %, or about 80 wt. % to about 86 wt. %), from about 3 wt. % to about 20 wt. % hydrogen (e.g., about 3 wt. % to about 5 wt. %, about 5 wt. % to about 10 wt. %, about 10 wt. % to about 15 wt. %, or about 15 wt. % to about 20 wt. %). As described herein, a mixed solid waste can be heated and/or mixed prior to being combined with the other component(s) of a composite. In some cases, such a thermomechanically processed mixed solid waste can have a water content of, for example, less than about 5 wt. % (e.g., less than about 4 wt. %, less than about 3 wt. %, less than about 2 wt. %, less than about 1 wt. %, about 0.1 to about 4 wt. %, about 0.5 to about 2 wt. %, about 1 to about 3 wt. %, about 2 to about 4 wt. %, or about 3 to about 5 wt. %).

In addition to a solid waste composition, the composites provided herein contain concrete, cement, or one or more cement-like binders or cement components (e.g., lime, sand, clay, shale, and/or iron ore). In general, cement can contain various mixtures of the aforementioned components, while concrete can contain a combination of cement or a cement-like binder, water, and optionally crushed stone or sand. Cement is a binder that can set, harden, and adhere to other material (e.g., sand or gravel) to bind them together. When mixed with fine aggregate, cement can yield mortar, while cement mixed with sand and/or gravel can yield concrete.

The composites provided herein can include from about 10 wt. % to about 75 wt. % of the solid waste composition and from about 5 wt. % to about 70 wt. % of the concrete, cement, cement-like binder(s), or cement component(s). For example, the composites can contain from about 10 wt. % to about 20 wt. %, about 20 wt. % to about 30 wt. %, about 30 wt. % to about 40 wt. %, about 40 wt. % to about 50 wt. %, about 50 wt. % to about 60 wt. %, about 60 wt. % to about 70 wt. %, about 30 to about 75 wt. %, or about 50 to about 75 wt. % of the solid waste composition, and from about 5 wt. % to about 10 wt. %, about 10 wt. % to about 20 wt. %, about 15 wt. % to about 30 wt. %, about 20 wt. % to about 25 wt. %, about 25 wt. % to about 40 wt. %, about 40 wt. % to about 50 wt. %, about 50 wt. % to about 60 wt. %, or about 60 wt. % to about 70 wt. % of the concrete, cement, cement-like binder(s), or cement component(s).

The composites provided herein also can, in some cases, include an aggregate (e.g., sand, gravel, crushed rock, air cooled blast furnace slag, or fill). For example, a composite can include from about 0 wt. % to about 75 wt. % aggregate (e.g., about 5 to about 10 wt. %, about 10 to about 20 wt. %, about 20 to about 30 wt. %, about 30 to about 40 wt. %, about 40 to about 50 wt. %, about 50 to about 60 wt. %, or about 60 to about 75 wt. % aggregate). In some cases, a composite provided herein can contain a ratio of solid waste composition plus aggregate (if any) to cement of about 3:1, about 4:1, about 5:1, about 6:1, about 8:1, or about 10:1.

In final form, the composites provided herein may contain from about 0.1 wt. % to about 15 wt. % water (e.g., about 0.1 wt. % to about 0.5 wt. %, about 0.5 wt. % to about 1 wt. %, about 1 wt. % to about 2 wt. %, about 2 wt. % to about 3 wt. %, about 3 wt. % to about 5 wt. %, about 5 wt. % to about 10 wt. %, or about 10 wt. % to about 15 wt. % water). At least part of the water may have come from the solid waste composition. In some cases, the water within a composite can be residual water that was added to promote setting of the cement or concrete. In general, the input moisture from a solid waste composition in a composite provided herein can range from about 0.5 wt. % to about 5 wt. % (e.g., about 0.5 wt. % to about 1 wt. %, about 1 wt. % to about 1.5 wt. %, about 1.5 wt. % to about 2 wt. %, about 2 wt. % to about 2.5 wt. %, about 2.5 wt. % to about 3 wt. %, about 3 wt. % to about 4 wt. %, or about 4 wt. % to about 5 wt. %). The input moisture from the solid waste composition can vary depending on particle size of the thermomechanically processed mixed solid waste input. For example, a composition containing a solid waste composition with smaller particles may have a lower moisture content (e.g., about 0.5 wt. % to about 5 wt. %) than a composition containing a solid waste composition with larger particles. It is to be noted that before curing, a mixed composition containing solid waste and cement, a cement component, or a cement-like material can have an internal relative humidity of about 80% to about 85% or higher, in order to allow for proper curing. Methods for measuring relative humidity in concrete and concrete products are guided by, for example, American Society for Testing and Materials (ASTM) F2170 standard. In some cases, the moisture content of a composite provided herein can result in a relative humidity that is equivalent to or within about 10% higher or lower than the relative humidity of known concrete materials.

In some cases, before it is set, a composite provided herein can include a solid waste composition (e.g., from about 10 wt. % to about 75 wt. % of the solid waste composition), cement (e.g., from about 5 wt. % to about 35 wt. %, such as about 5 wt. % to about 10 wt. %, about 10 wt. % to about 20 wt. %, about 20 wt. % to about 30 wt. %, or about 30 wt. % to about 35 wt. %, of the cement), and water (e.g., from about 5 wt. % to about 15 wt. % water, such as about 5 wt. % to about 10 wt. %, or about 10 wt. % to about 15 wt. %). After setting, a composite can include a solid waste composition (e.g., from about 5 wt. % to about 75 wt. % of the solid waste composition), concrete (e.g., from about 10 wt. % to about 70 wt. % of the concrete), and a small amount of water (e.g., less than about 5 wt. % water, such as about 0.1 wt. % to about 5 wt. % water), since much of the water will evaporate during setting.

In some cases, a composite can further include one or more added polymers in addition to any polymers and/or plastics that are present in the solid waste composition. The added polymer can be present in a composite in an amount that is about 1 wt. % to about 70 wt. % (e.g., about 2 wt. % to about 5 wt. %, about 5 wt. % to about 10 wt. %, about 10 wt. % to about 20 wt. %, about 20 wt. % to about 30 wt. %, about 30 wt. % to about 40 wt. %, about 40 wt. % to about 50 wt. %, about 50 wt. % to about 60 wt. %, or about 60 wt. % to about 70 wt. %) of the composite. In some embodiments, a composite provided herein can have a total amount of plastics (an amount that includes plastic in the solid waste material and any added polymer) that is from about 0 wt. % to greater than 90 wt. % (e.g., about 0.1 wt. % to about 3 wt. %, about 3 wt. % to about 5 wt. %, about 5 wt. % to about 10 wt. %, about 10 wt. % to about 20 wt. %, about 20 wt. % to about 40 wt. %, about 40 wt. % to about 60 wt. %, about 60 wt. % to about 70 wt. %, about 70 wt. % to about 80 wt. %, about 80 wt. % to about 90 wt. %, greater than 65 wt. %, greater than 70 wt. %, greater than 75 wt. %, greater than 80 wt. %, or greater than 90 wt. %).

Any appropriate polymer can be included in the composites provided herein. In some cases, for example, an added polymer can include a thermoset resin. The inclusion of a polymer such as a thermoset resin can increase the structural integrity of the finished product, and can allow continuous hardening of the product when exposed to sun (UV rays) and/or heat. Examples of thermoset resins that can be added to a pre-processed raw material include, without limitation, epoxy resins, fiberglass-reinforced plastic, phenolic resins, polyester resins, polyurethanes including elastomeric polyurethanes, polyurea/polyurethane hybrids, furan resins, silicone resins, vinyl ester, cyanate esters, melamine resins, polydicyclopentadiene, benzoxazines, polyimides, bismaleimides, an electrical insulating thermoset phenolic laminate material (e.g., THIOLYTE®), nylons, fluoropolymers, polystyrene, polypropylene, and combinations thereof. When included in a composite provided herein, the one or more added polymers (e.g., one or more thermosetting polymers) can be added in an amount such that the end product contains from about 1 wt. % to about 70 wt. % (e.g., about 1 wt. % to about 5 wt. %, about 5 wt. % to about 10 wt. %, about 10 wt. % to about 20 wt. %, about 20 wt. % to about 50 wt. %, about 30 wt. % to about 70 wt. %, about 5 wt. % to about 25 wt. %, about 20 wt. % to about 40 wt. %, about 40 wt. % to about 50 wt. %, about 50 wt. % to about 60 wt. %, or about 60 wt. % to about 70 wt. %) of the added polymer(s). In some cases, the amount of polymer added to a solid waste composition can increase the total amount of plastics in the resulting composition product by at least about 0.5% (e.g., at least about 1%, at least about 5%, at least about 10%, about least about 20%, at least about 30%, at least about 40%, at least about 50%, at least about 60%, at least about 70%, at least about 75%, at least about 80%, at least about 90%, or at least about 100%), as compared to the amount of plastics in the solid waste composition alone.

Without being bound by a particular mechanism, the inclusion of one or more thermoset resins in a composite provide herein can impart increased structural strength to products (e.g., construction products) produced from the composite. Conventional concrete typically has a compressive strength (measured in pounds per square inch, or psi) of about 3000 to 5000 psi. For example, 3000 psi concrete can be used for driveways, sidewalks, or patios, while 4000 psi concrete can serve as floor slabs for residential and commercial construction, and 5000 psi concrete can be used in construction applications requiring heavy impact or significant load-bearing. Some polymers (e.g., epoxy resins) can have strengths of 10,000 psi once cured. In addition, some polymers can cure much faster than concrete, curing in about 24 to 72 hours rather than the 7 to 28 days typically required for concrete. Thus, a composite containing one or more thermoset (e.g., epoxy) resins in combination with a solid waste composition and cement, concrete, or a similar material can yield a finished product having a strength equal to or greater than conventional concrete. In some cases, a composite can have a compressive strength that is at least 5% (e.g., at least 10%, at least 15%, at least 20%, at least 30%, at least 40%, at least 50%, at least 60%, at least 70%, at least 80%, at least 90%, or at least 100%) greater than the compressive strength of the solid waste composition. As used herein, “compressive strength” refers to the actual (e.g., measured) compressive strength of a composite provided herein, which typically is referred to in the art as the “ultimate” compressive strength.

In some cases, a composite provided herein can have a compressive strength of about 1000 to about 2500 psi (e.g., about 1000 to about 1500 psi, about 1500 to about 2000 psi, or about 2000 to about 2500 psi). Such composites may be useful for, without limitation, landscaping, ground cover, and walkways, and may contain a higher ratio of solid waste composition to cement than composites with a higher compressive strength. Such composites also may lack, or have a lower amount of, added polymer than composites with a higher compressive strength. In some cases, a composite provided herein can have a compressive strength of about 2500 psi to about 4000 psi (e.g., about 2500 to about 3000 psi, about 3000 to about 3500 psi, or about 3500 to about 4000 psi). In some cases, a composite provided herein can have a compressive strength greater than about 5000 psi (e.g., about 5000 to 6000 psi, about 6000 to 7000 psi, about 7000 to 8000 psi, about 8000 to 9000 psi, or about 9000 to 10,000 psi). Composites having a higher compressive strength may contain a lower ratio of solid waste composition to cement than composites with a lower compressive strength. Such composites also may contain a greater amount of added polymer than composites having a lower compressive strength.

The composites provided herein also can include one or more components in addition to a pre-processed mixed solid waste (e.g., a thermomechanically processed mixed solid waste), cement/concrete, and added polymer(s). For example, a composite can contain one or more recycled plastics, PLA, wood waste (e.g., sawdust), biocides, and/or flame retardant materials.

In some cases, for example, a composite can contain one or more biocides, which can reduce or prevent growth of pathogens such as, without limitation, molds, fungi, bacteria, and/or yeast. Examples of biocides that can be included are copper azole (CuAz), ammoniacal copper quaternary (ACQ), 4,5-dichloro-2-octyl-isothiazolone, zinc pyrithione, and carbendazim. In some cases, a natural, environmentally-friendly wood sealer (e.g., tung oil, linseed, or beeswax) can be used as an alternative to a synthetic biocide. A composite can include any appropriate amount of one or more biocides (e.g., about 0.0001 wt. % to about 1 wt. %, about 0.0001 to about 0.001 wt. %, about 0.001 to about 0.01 wt. %, about 0.01 to about 0.1 wt. %, or about 0.1 to about 1 wt. %).

In some cases, a composite provided herein can contain one or more flame retardant materials that provide for fire-proofing or fire retardation. Examples of suitable flame retardants include, without limitation, phosphate flame retardants, silicon-based flame retardants, metal hydroxide flame retardants, melamine flame retardant, phosphorus-based flame retardants, halogenated flame retardants, and brominated flame retardants. In some cases, a composite can contain one or more polymeric flame retardants, retardant coatings made from bio-based chitosan, phytic acid and divalent metal ions, or other types of ecologically-friendly flame retardants. A composite can include any appropriate amount of one or more flame retardant materials (e.g., about 0.0001 wt. % to about 1 wt. %, about 0.0001 to about 0.001 wt. %, about 0.001 to about 0.01 wt. %, about 0.01 to about 0.1 wt. %, or about 0.1 to about 1 wt. %).

In some cases, a composite provided herein can contain about 10 wt. % to about 70 wt. % solid waste composition (or solid waste composition mixed with aggregate), about 5 wt. % to about 70 wt. % cement, about 1 wt. % to about 70 wt. % added polymer, about 0.0001 wt. % to about 1 wt. % additive, and about 0.1 wt. % to about 15 wt. % water.

The composites provided herein can have any appropriate tensile strength, compressive strength, and/or flexural modulus. For example, a composite can have a tensile strength that is at least 5% (e.g., at least 10%, at least 15%, at least 20%, at least 30%, at least 40%, at least 50%, at least 60%, at least 70%, at least 80%, at least 90%, or at least 100%) greater than the tensile strength of the solid waste composition. For example, a composite can have a tensile strength of about 250 psi to about 750 psi (e.g., about 250 to about 350 psi, about 350 to about 450 psi, about 450 to about 550 psi, about 550 to about 650 psi, or about 650 to about 750 psi). In some cases, the tensile strength may exceed 750 psi. In some cases, a composite provided herein can have a tensile strength of about 1.7 MPa to about 5.2 MPa (e.g., about 1.7 to about 2.2 MPa, about 2.2 to about 2.7 MPa, about 2.7 to about 3.2 MPa, about 3.2 to about 3.7 MPa, about 3.7 to about 4.2 MPa, about 4.2 to about 4.7 MPa, or about 4.7 to about 5.2 MPa). In some cases, the tensile strength may exceed 5.2 MPa.

In some cases, a composite can have a flexural modulus that is at least 5% (e.g., at least 10%, at least 15%, at least 20%, at least 30%, at least 40%, at least 50%, at least 60%, at least 70%, at least 80%, at least 90%, or at least 100%) greater than the flexural modulus of the solid waste composition. For example, a composite provided herein can have a flexural modulus that is about 10% to about 25% of the composite's compressive strength (e.g., about 10% to about 15%, about 15% to about 20%, or about 20% to about 25% of the composite's compressive strength).

Any suitable method can be used to determine the tensile strength, the compressive strength, and/or the flexural modulus of a composite and/or a solid waste composition. For example, tensile strength can be measured using the split cylinder test of concrete method. Compressive strength can be measured by, for example, testing of concrete cylinders and as described by the procedures in American Society for Testing and Materials (ASTM) C 39. Flexural strength can be calculated as a function of tensile strength.

This document also provides methods and systems for producing the composites provided herein. In some cases, the methods, materials, and systems can make use of certain aspects of the methods and systems described in U.S. Pat. Nos. 9,771,536 and 10,618,025. Processes and systems as described, for example, in U.S. Pat. Nos. 9,771,536 and 10,618,025, which are incorporated herein by reference in their entirety, can be used to form the solid waste composition, and/or to form, at least in part, the composites provided herein.

For example, the present document provides methods and materials for producing sustainable products (e.g., sustainable building materials) from mixed solid waste streams. In some cases, the methods provided herein can include using a front-end sorting operation to remove metals, glass, and/or rocks/aggregate from a solid waste stream. For example, magnets can be used to remove ferrous metals, an Eddy Current Separator can be used to remove non-ferrous metals (which also can be removed manually), a Trommel Screen can be used to remove oversized material, and/or an air sorter can be used to remove glass. All other materials, including food waste and other organic material, can remain in the solid waste stream unsorted. In some cases, the methods provided herein can include heating at least the solid waste materials (e.g., in a negative pressure environment), which can have the effect of removing substantially all of the moisture from the solid waste composition. Certain components of solid waste can have a high moisture content. For example, food waste can have a moisture content of about 70% and can initially make up a substantial portion of the incoming MSW stream. Removal of most (e.g., substantially all) moisture content from the food waste can reduce the significance of its presence, and can facilitate greater control over the moisture content after addition of the cement or concrete components. In addition, since the process further brings the material to low torrefaction temperatures, including temperatures at which thermal decomposition of some of the materials (e.g., hemicellulose and cellulose) occurs, the process can act as a thermal pretreatment of the paper, paperboard, textiles, wood, and dry components of the food waste.

In some cases, the methods provided herein for producing sustainable products (e.g., sustainable building materials) from mixed solid waste streams can include heating and mixing a mixed solid waste (e.g., in a process vessel such as a barrel) to a temperature sufficient to reduce the water content of the mixed solid waste and/or to melt at least a portion of the plastics contained within the mixed solid waste. Any appropriate temperature can be used. In some cases, for example, a mixed solid waste can be heated to a temperature of about 38° C. to about 210° C. (e.g., about 38° C. to about 45° C., about 45° C. to about 60° C., about 60° C. to about 70° C., about 70° C. to about 80° C., about 80° C. to about 90° C., about 90° C. to about 100° C., about 100° C. to about 105° C., about 105° C. to about 110° C., about 110° C. to about 120° C., about 120° C. to about 130° C., about 130° C. to about 140° C., about 140° C. to about 150° C., about 150° C. to about 160° C., about 160° C. to about 170° C., about 170° C. to about 180° C., about 180° C. to about 190° C., about 190° C. to about 200° C., or about 200° C. to about 210° C.). In some cases, the temperature to which the mixed solid waste is heated can be within a range that is sufficient to substantially remove microbes that may be present in the mixed solid waste during the processing. This can eliminate (or at least reduce the likelihood of) degradation of the material and corresponding reduction in structural integrity, which otherwise might result from the presence of viable microbes in the raw material feedstock. Moreover, the use of temperatures that allow at least a portion of the plastic content of the mixtures to melt can help to facilitate the distribution of plastics within the solid waste material. Further, in some cases, air can be removed from the process vessel during heating, in order to reduce the likelihood of combustion that otherwise might occur due to the presence of oxygen in the vessel. A mixed solid waste can be heated and/or mixed for any suitable length of time (e.g., about 20 minutes to about 30 minutes, about 30 minutes to about 60 minutes, about 1 hour to about 2 hours, about 2 hours to about 4 hours, about 4 hours to about 6 hours, about 6 hours to about 8 hours, or about 8 hours to about 12 hours).

In some cases, during processing of a mixed solid waste (e.g., by heating and mixing), the mixed solid waste also can be granulated (e.g., using a mill, such as a high speed low torque, rotor knife mill). The granules can have any appropriate average size. In some cases, the granules can have an average size of about 1/16 inch, 1/32 inch, or about 1/64 inch. Depending on their size, the granules may be particularly useful for certain applications. For example, pre-processed mixed solid waste containing particles with a larger size can be well suited for use in concrete substitutes, while pre-processed mixed solid waste containing particles with a smaller size can be well suited for use in masonry type composites.

In some cases, the methods provided herein for treating (e.g., heating and melting) a solid waste composition can be carried out using a process vessel. Representative examples of process vessels are described in U.S. Pat. Nos. 9,771,536 and 10,618,025, which are incorporated herein by reference in their entirety.

During or after pre-processing of a mixed solid waste, concrete or cement (or one or more cement-like binders or cement components) and water can be mixed with the solid waste composition. In some cases, a component such as a conveyor, a die, a mold, or a combination thereof can be coupled to an opening in the processing vessel or to a flange that serves to narrow the diameter of the system by about 25% to about 75%, (e.g., about 50%, such as from about 20 inches to about 10 inches). For example, a conveyor (e.g., a shaftless spiral conveyor, a ribbon screw conveyor, or a conventional screw conveyor) can be coupled to an opening (e.g., via a flange) in a processing vessel in order to move the pre-processed raw material toward a mold for forming into a building product. Using a component that is narrower than the barrel can allow the pre-processed raw material to be densified, even if the material is then permitted to expand during a later step (e.g., during movement along a ribbon or shaftless spiral conveyor). The densifying step is optional, however, and in some cases, a processing vessel can be extended to an attachment that is external to the system, where the attachment has substantially the same diameter as the vessel.

The methods provided herein include introducing concrete, or cement (or one or more cement-like binders or cement components) and water, to a pre-processed (e.g., heated and mixed) raw material before it is formed into a product. For example, heated and mixed waste material can be fed from the processing vessel into a mixing conveyor (e.g., a ribbon screw conveyor or a shaftless spiral conveyor), which can enable the introduction of concrete, cement, water, and any other appropriate additives at a temperature below that to which the waste material was exposed when it was in the processing vessel. In some cases, water can be used to cool the pre-processed waste material before or after it is fed into a conveyor.

In some cases, one or more hoppers can be connected to or positioned along a conveyor. Each of the one or more hoppers can contain an additive that can be introduced into the pre-processed raw material as it passes through or along the conveyor. In other cases, the heated and mixed waste material can be moved from the barrel into a mixing vessel (e.g., a vertical mixing vessel) so that cement, concrete, water, and any other additives can be introduced and the material can be blended. Any appropriate additive or combination of additives can be introduced.

In some cases, one or more polymers (e.g., one or more thermosetting resins) also can be added during production of a composite provided herein. A polymer can be added in any appropriate amount and at any appropriate temperature. In some cases, suitable temperatures for adding one or more polymers (e.g., thermoset resins) to a solid waste composition can be less than about 70° C. (e.g., about 40 to about 50° C., about 50 to about 60° C., or about 60 to about 70° C.). The polymer(s) can be added at any appropriate point, including before, during, or after heating of the solid waste composition. For example, one or more polymers can be mixed with a solid waste composition before or during heating of the solid waste composition (e.g., in a process vessel). In such cases, the added polymer(s) can become substantially evenly mixed with the solid waste composition. In addition, heating the mixture can cause at least a portion of the added polymer(s) to melt along with mixed plastics that may be present in the solid waste composition. The one or more polymers also can fill spaces within the mixed solid waste, which can contribute to a very strong, consistent composite product. In some cases, one or more polymers can be added after the solid waste composition has been heated.

In some cases, a method provided herein also can include adding one or more additional components to a pre-processed solid waste composition. Examples of suitable additional components include, without limitation, recycled plastics and PLA.

For example, one or more biocides can be added during production of a composite provided herein. The inclusion of a biocide can reduce or prevent growth or detrimental effects of pathogens (e.g., molds, fungi, bacteria, or yeast) and other organisms (e.g., insects or rodents) in the products provided herein. Any appropriate biocide or combination of biocides can be added. Examples of suitable biocides include, without limitation, CuAz, ACQ, 4,5-dichloro-2-octyl-isothiazolone, zinc pyrithione, and carbendazim. One or more biocides can be added to a pre-processed raw material at any suitable temperature, such as a temperature less than 50° C. (e.g., about 35 to about 40° C., about 40 to about 45° C., or about 45 to about 50° C.). Any suitable amount of biocide can be added. In some cases, a solution containing one or more biocides can be added to a composite mix (e.g., a mix that includes a solid waste composition and cement, optionally with one or more added polymers or other additives) at about 0.01 wt. % to about 15 wt. % (e.g., about 0.01 wt. % to about 0.1 wt. %, about 0.1 to about 1 wt. %, about 1 to about 5 wt. %, about 5 to about 10 wt. %, or about 10 to about 15 wt. %), prior to drying/curing of the composite.

One or more biocides can be added to a composite provided herein using any appropriate method. In some cases, for example, a process for making a composite provided herein can include blending or mixing a biocide into a solid waste composition prior to formation of a final composite form. In such methods, the biocide is added while the solid waste composition is in a softened state, and is blended for distribution throughout the solid waste composition. In some cases, however, a biocide can be applied to a composite provided herein by a method that includes brushing, spreading, spraying, deluging, fogging, immersion, hot and/or cold steeping, diffusion, pressure impregnation, using a double vacuum, or combinations thereof.

In some cases, one or more flame retardant materials can be added during production of a composite provided herein, to confer fire-proofing or fire retardation to the finished product. Examples of suitable flame retardants include, without limitation, phosphate flame retardants, silicon-based flame retardants, metal hydroxide flame retardants, melamine flame retardant, phosphorus-based flame retardants, halogenated flame retardants, and brominated flame retardants. In some cases, polymeric flame retardants, retardant coatings made from bio-based chitosan, phytic acid and divalent metal ions, or other types of ecologically-friendly flame retardants can be used. Any suitable amount of flame retardant can be added. In some cases, a solution containing one or more flame retardants can be added to a composite mix (e.g., a mix that includes a solid waste composition and cement, optionally with one or more added polymers or other additives) at about 0.01 wt. % to about 15 wt. % (e.g., about 0.01 wt. % to about 0.1 wt. %, about 0.1 to about 1 wt. %, about 1 to about 5 wt. %, about 5 to about 10 wt. %, or about 10 to about 15 wt. %), prior to drying/curing of the composite. One or more flame retardants can be added to a composite provided herein by any appropriate method. For example, a flame retardant can be incorporated into a solid waste composition during the blending and mixing phase, prior to forming a final composite product.

After all of the desired components (the cement/concrete and optionally one or more added polymers and/or additives) have been sufficiently combined with the pre-processed raw material, the combined material can be passed into a mold. In some cases, for example, the combined material can be fed (e.g., via a hopper) into an extruder (e.g., a screw extruder), which can push the combined material through a die and into a mold. The hopper and/or the screw extruder can be heated to maintain the combined material at a suitable temperature until it is placed into the mold. The mold can have any appropriate shape and size.

In some cases, rather than combining one or more additives with a pre-processed raw material in a mixing conveyor or other mixing vessel that is separate from the barrel of the processing vessel, the barrel itself can be used for addition and/or blending of one or more additives. In such cases, the temperature of the processor can be modified to bring the pre-processed raw material to the a suitable temperature for each respective additive (e.g., less than 70° C. for thermoset resins, or less than 50° C. for biocides). After cement, water, and any other additives have been sufficiently combined with the pre-processed raw material, the combined mixture can be fed into a mold. For example, the combined mixture can be passed from the processor barrel through a customized die attached to an output flange that is reversibly or irreversibly attached to the barrel. The combined material can be moved (e.g., pushed or injected) through the die and into a mold having any appropriate shape and size.

In certain embodiments, the composites provided here can used as masonry products. When a masonry product is being produced, for example, the formed composite can have any appropriate dimensions. For example, a composite product can have a shape and size consistent with standard masonry products (e.g., bricks, cinder blocks, pavers, retaining wall blocks, etc.). In some cases, the actual dimensions of the formed composite can be about 0.025 to about 0.05 inch less than the dimensions of a standard masonry products. The edges of the composite can be squared, rounded, or grooved, for example.

In some cases, the composites provided herein can be formed into blocks, e.g., stackable blocks using the methods provided herein. The blocks can be solid can include one or more openings (e.g., as in a cinder block). In some cases, interlocking blocks can be generated with one or more protrusions or ridges and one or more apertures or ridges, such that adjacent blocks can fit together in a particular orientation. For example, LEGO® style blocks can have one or more protrusions capable of interlocking with one or more openings in adjacent blocks. Such blocks can be used, for example, as building blocks for consumer applications (e.g., retaining walls, accessory buildings such as garden sheds, or structural framework within walls). In some cases, blocks with openings extending therethrough (e.g., openings extending between a first side of the block and an opposite side of the block) can be filled with cement, concrete, or any other suitable material (e.g., sand) to add strength and stability to a structure constructed from the blocks. In some cases, one or more openings through in a first block can align with one or more openings through a second block positioned adjacent to the first block, such that the openings can be filled with concrete or another material (e.g., sand) in a contiguous manner. For example, two or more blocks can be positioned one on top of the other, with one or more aligning apertures extending between the top and bottom surfaces of each block, such that cement, concrete, or another substance can be placed into each of the aligned apertures from the top down, resulting in a segment of the cement, concrete, or other substance that is contiguous within the wall structure. In some cases, one or more apertures through a block (e.g., one or more openings formed during molding or drilled through the block after forming) can be configured to allow for insertion of rebar. The one or more openings can be at locations that align when blocks are placed adjacent to one another, such that a single rebar piece can extend through more than one block.

In some cases, the composites described herein can be formed by a mold that includes an opening (e.g., a slot or pin hole) at an end or a position opposite the entry point for the pre-processed raw material. The opening can have a size sufficient for visual confirmation that the mold has been filled to a sufficient level. After the mold is filled, extrusion of the processed raw material can be stopped or paused, the mold can be detached from the die, a new mold can be attached, and extrusion of the processed raw material into the newly attached mold can begin. The filled mold can be removed and replaced with an empty mold manually, or the procedure can be achieved with an automated system.

In some cases, the composites provided herein can be used for 3D printing to generate composite products (e.g., structural or non-structural composite products). In addition, in some cases, the composites provided herein can be poured into a form to produce sidewalks, foundations, roads, etc.

When a composite product described herein is formed in a mold, the filled mold can be allowed to cool so that once the material contained therein (the product) is removed from the mold, expansion of the formed composite product is reduced or prevented. After cooling and hardening, the formed composite product can be removed from the mold.

In some cases, a coating (e.g., a coating of cement or another material, such as a polymer or polymer-based material) can be applied to one or more outer surfaces of a formed structural composite that contains a solid waste composition, regardless of whether the formed composite contains cement or other additives. In some cases, the coating forms a shell around part or all of the composite. The coating may be applied for functional (e.g., weather-proofing or prevention of damage from insects or rodents) and/or aesthetic purposes (e.g., to provide a particular color and/or texture). In some cases, for example, a cement coating can yield a product having a traditional concrete appearance. Examples of polymers that can be applied to the outer surface of a structural composite include, without limitation, epoxys, epoxy-polyester hybrids, urethane polyester, polyester TGIC, acrylics, polyvinyl chloride, polyolefins, nylon, polyesters, and polyvinylidene fluoride. A coating can be applied using any appropriate method (e.g., spraying, dipping, pouring, or powder coating).

In some embodiments, a composite can be formed into a smaller block (e.g., shaped as a brick, a concrete block, a cinder block, a flue, a concrete masonry unit, a paver, a float, an edging brick, a panel, or a stone, such a natural or field stone) using shell mold casting or injection molding with at least first and second molds. The shape of the first mold into which the composite is cast can be similar to that of a conventional masonry product, except its size can be reduced roughly proportionally by about 10% to 80% (e.g., about 10% to about 25%, about 25% to about 40%, about 40% to about 60%, or about 50% to about 80%). The second mold can be larger, with a size consistent with that of a standard masonry building material (e.g., a standard brick, concrete block, or cinder block). After using the first mold to product a structural composite, the second mold can be partially filled with pure cement, concrete, mortar, or a similar substance, and the formed structural composite can be placed into the partially filled second mold such that the structural composite is partially or completely coated with or encased in concrete or cement, for example. After curing, the resulting product can be a cement, concrete, mortar, brick, or similar type product in which the core is made of recycled, thermally-processed solid waste.

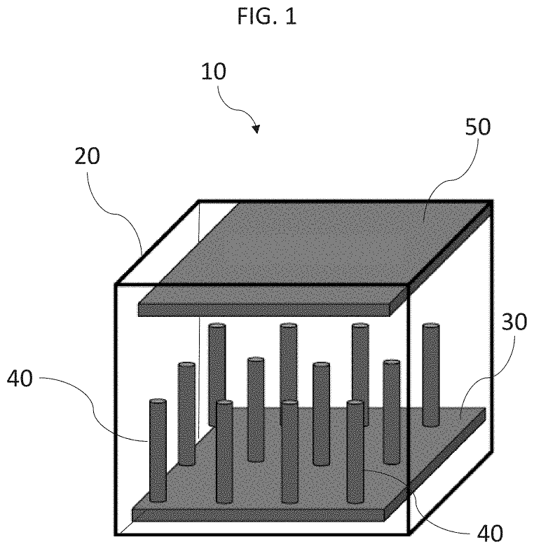

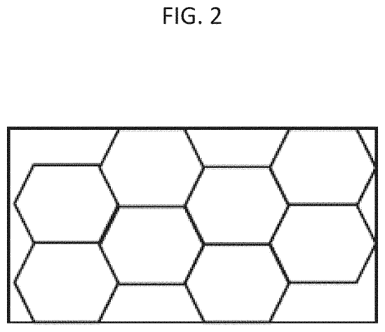

In some cases, the methods provided herein also can include adding one or more elements that can provide increased compressive strength to a structural composite product. For example, a composite containing a solid waste composition and cement can be formed into a structural composite product that contains one or more reinforcing elements. As depicted in FIG. 1, for example, a mold can include reinforcing elements that will be contained within a finished product: mold 10 can include outer shell 20 and internal reinforcing elements that are not attached to outer shell 20, such that the reinforcing elements can be incorporated into a composite structural product and removed from mold 10 along with the composite from which the product is made. The reinforcing elements depicted in FIG. 1 include plate 30 and protrusions 40, as well as plate 50. A composite containing a solid waste composition and cement can be placed (e.g., extruded or injected) into outer shell 20, such that the composite encases plate 30 and protrusions 40. Plate 50 then can be pressed into the composite to provide additional strength. In some cases, a composite can be placed into a mold, and one or more reinforcing elements (e.g., a plate having protrusions similar to plate 30 and protrusions 40) can be inserted into the composite before it cures. Another example of a configuration for a reinforcing element is depicted in FIG. 2, which illustrates a honeycomb structure that can be inserted into a composite (or can be included in a mold into which a composite is inserted) in order to provide structural support and strength to the resulting structural composite.

A reinforcing element can include any appropriate material. In some cases, for example, a reinforcing element made from a thermoset resin (e.g., an epoxy resin, which may have a compressive strength of about 10,000 psi) can be used to impart strength and/or structural integrity to a structural composite. It is to be noted that in some cases, one or more reinforcing elements described herein can be used with a composite that contains a solid waste composition but does not contain concrete or cement.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A composite comprising:
cement; and
a solid waste composition comprising organic material and about 2 wt. % to about 65 wt. % mixed plastics, wherein the solid waste composition comprises:
from about 40 wt. %. to about 86 wt. % carbon;
from about 3 wt. % to about 20 wt. % hydrogen;
oxygen; and
from about 0.1 wt. % to about 15 wt. % water.

2. The composite of claim 1, wherein the solid waste composition was heated to a temperature of 38° C. to 210° C. prior to being combined with the cement.

3. The composite of claim 1, wherein the composite has a compressive strength of at least 5000 psi.

4. The composite of claim 1, wherein the composite has a compressive strength that is at least 50% greater than the compressive strength of the solid waste composition.

5. The composite of claim 1, wherein the mixed plastics comprise two or more plastics selected from the group consisting of polyester, polyethylene terephthalate, polyethylene, polyvinyl chloride, polyvinylidene chloride, polypropylene, polystyrene, polyamides, acrylonitrile-butadiene-styrene, polyethylene/acrylonitrile-butadiene-styrene, polycarbonate, polycarbonate/acrylonitrile butadiene styrene, polyurethanes, maleimide/bismaleimide, melamine formaldehyde, phenol formaldehydes, polyepoxide, polyetheretherketone, polyetherimide, polyimide, polylactic acid, polymethylmethacrylate, polytetrafluoroethylene, and urea-formaldehyde.

6. The composite of claim 1, wherein the solid waste composition is derived from municipal solid waste, agricultural waste, or both.

7. The composite of claim 1, further comprising an aggregate material.

8. The composite of claim 1, further comprising an added polymer.

9. The composite of claim 8, wherein the added polymer comprises a thermoset polymer.

10. The composite of claim 8, wherein the added polymer comprises an epoxy resin, a fiberglass-reinforced plastic, a phenolic resin, a polyester resin, polyurethane, a polyurea/polyurethane hybrids, a furan resin, a silicone resin, a vinyl ester, a cyanate ester, a melamine resin, a polydicyclopentadiene, benzoxazine, a polyimide, a bismaleimide, an electrical insulating thermoset phenolic laminate material, a nylon, polystyrene, polypropylene, a fluoropolymer, or any combination thereof.

11. The composite of claim 1, further comprising one or more of a flame retardant, a biocide, or an additive comprising recycled plastic or polylactic acid (PLA).

12. The composite of claim 1, wherein the composite is in the form of a board, a plank, a stud, a block, an interlocking block, a brick, a strut, a beam, an H-block, a flue, a concrete masonry unit, a paver, a float, an edging brick, a panel, or a stone-shape.

13. The composite of claim 1, comprising about 10 wt. % to about 75 wt. % of the solid waste composition and about 10 wt. % to about 30 wt. % of cement.

14. A composite comprising:
cement; and
a solid waste composition comprising mixed plastics and organic material, and
water in an amount of about 0.1 wt. % to about 2 wt. %.

15. A method of making a composite, the method comprising:
heating, in a process vessel, a solid waste composition comprising:
mixed plastics in an amount of about 2 wt. % to about 70 wt. % of the solid waste composition; and
organic materials;
such that at least a portion of the mixed plastics in the solid waste composition become melted; and
during or after the heating, combining cement with the solid waste composition.

16. The method of claim 15, wherein the structural composite comprises about 10 wt. % to about 30 wt. % of the cement.

17. The method of claim 15, further comprising combining an aggregate material with the solid waste composition and the cement.

18. The method of claim 15, further comprising adding a thermoset polymer to the composition, wherein the thermoset polymer comprises an epoxy resin, a fiberglass-reinforced plastic, a phenolic resin, a polyester resin, polyurethane, a polyurea/polyurethane hybrids, a furan resin, a silicone resin, a vinyl ester, a cyanate ester, a melamine resin, a polydicyclopentadiene, benzoxazine, a polyimide, a bismaleimide, an electrical insulating thermoset phenolic laminate material, a nylon, polystyrene, polypropylene, a fluoropolymer, or any combination thereof.

19. The method of claim 15, further comprising adding to the composition a filler comprising recycled plastic, PLA, or a resin.

20. The method of claim 15, further comprising adding to the composition a biocide or a flame retardant.
